(19) United States
(12) Patent Application Publication
(10) Pub. No.: US 2024/0222915 A1
(43) Pub. Date: Jul. 4, 2024

(54) Battery-Powered Extension Cord Device

(71) Applicant: Kimberly Gordon, Pomeroy, WA (US)

(72) Inventor: Kimberly Gordon, Pomeroy, WA (US)

(21) Appl. No.: 18/479,901

(22) Filed: Oct. 3, 2023

Related U.S. Application Data
(60) Provisional application No. 63/435,566, filed on Dec. 28, 2022.

(51) Int. Cl. H01R 13/66; H02G 11/02

(52) U.S. Cl. CPC H01R 13/6675; H01R 13/6691; H02G 11/02

(57) ABSTRACT

A battery-powered extension cord device is provided. The device is comprised of body comprised of an internal reel, wherein at least one power cord can be retracted and extended from the body via the reel. The power cord is comprised of a female power receptacle that can power an attached electronic device. The receptacle receives power from a battery of the device.

### CROSS-REFERENCE TO RELATED APPLICATION

The present application claims priority to, and the benefit of, U.S. Provisional Application No. 63/435,566, which was filed on Dec. 28, 2022, and is incorporated herein by reference in its entirety.

### FIELD OF THE INVENTION

The present invention relates generally to the field of extension cords. More specifically, the present invention relates to a battery-powered extension cord device that is comprised of a retractable power cord with a battery-powered receptacle. Accordingly, the present disclosure makes specific reference thereto. Nonetheless, it is to be appreciated that aspects of the present invention are also equally applicable to other like applications, devices, and methods of manufacture.

### BACKGROUND

Extension cords are indispensable tools in today's electronically-driven world. Extension cords are frequently used to bridge the gap between an electrical outlet and the varying appliances and tools that demand electrical power. However, extension cords are often constrained due to the lack of nearby electrical outlets.

While extension cords offer convenience, it's imperative to use them judiciously. Linking multiple extension cords together, a practice known as “daisy chaining,” poses significant risks. Such configurations can lead to overheating, which in turn, increases the chances of electrical fires. This is because the cumulative current flowing through the chained cords can exceed their designed capacity, compromising safety.

Moreover, unexpected power outages can be a major disruption, leaving individuals without the means to charge essential devices like smartphones or to power crucial appliances like refrigerators. In such situations, the absence of a reliable power source can impact one's ability to stay connected or even preserve perishable goods, emphasizing the significance of having a dependable power backup or alternative power solutions.

Therefore, there exists a long-felt need in the art for an improved extension cord. There also exists a long-felt need in the art for a battery-powered extension cord device. More specifically, there exists a long-felt need in the art for a battery-powered extension cord device that can be positioned near an electronic device it is powering without the need for daisy-chaining. Further, there exists a long-felt need in the art for a battery-powered extension cord device that can be positioned near an electronic device it is powering without the need for daisy-chaining, and wherein the device need not receive continuous electrical power from an electrical outlet.

The subject matter disclosed and claimed herein, in one embodiment thereof, comprises a battery-powered extension cord device. The device is comprised of a body comprised of an internal reel. At least one power cord can be retracted and extended from the body via the reel. The power cord is comprised of a female power receptacle that can power an attached electronic device. The receptacle receives power from a battery of the device.

In this manner, the battery-powered extension cord device of the present invention accomplishes all the forgoing objectives and provides an improved extension cord. More specifically, the device can be positioned near an electronic device it is powering without the need for daisy-chaining. Further, the device need not receive continuous electrical power from an electrical outlet

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a battery-powered extension cord device. The device is comprised of at least one battery which powers at least one power cord. As a result, the device can be positioned near an electronic device it is supplying power to and can do so without the need for an electrical outlet.

The device is comprised of a body comprised of at least one opening. The opening allows at least one power cord to exit the body. Within the body, the power cord is stored around at least one reel. The cord is comprised of a first end and a second end. The first end of the cord is in electrical communication with at least one battery within the body which provides power to the cord. In one embodiment, the battery is replaceable and disposable. In another embodiment, the battery via at least one charging port and/or via at least one male power cord that plugs into a 110 v/220 v wall outlet.

The second end of the power cord is comprised of at least one receptacle that is preferably a female 110 v/220 v power receptacle. As a result, the male plug of an electronic device can be plugged into the receptacle and powered by the device. At least one button on the body may allow a user to configure at least one timer of the device to allow a user to program the battery to only supply power to the receptacle for a specific period of time.

The present invention is also comprised of a method of using the device. First, a device is provided comprised of a body comprised of at least one reel, at least one power cord comprised of at least one receptacle, and at least one battery. Then, the power cord can be pulled from the body. Next, the male plug of an electronic device can be plugged into the receptacle such that the electronic device receives electrical power from the battery. The cord can then be retracted within the body when the electronic device is not in use.

In a second method of using the device, a device is provided comprised of a body comprised of at least one reel, at least one power cord comprised of at least one receptacle, and at least one battery. Then, the power cord can be pulled from the body. Next, the male plug of an electronic device can be plugged into the receptacle such that the electronic device receives electrical power from the battery. Then, at least one timer of the device can be configured to a specific time period wherein the battery will supply power to the receptacle. The cord can then be retracted within the body when the electronic device is not in use.

Accordingly, the battery-powered extension cord device of the present invention is particularly advantageous as it provides an improved extension cord. More specifically, the device can be positioned near an electronic device it is powering without the need for daisy-chaining. Further, the device need not receive continuous electrical power from an electrical outlet. In this manner, the battery-powered extension cord device overcomes the limitations of existing extension cords known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a battery-powered extension cord device of the present invention while the power cord is retracted into the body in accordance with the disclosed architecture;

FIG. 2 illustrates a perspective view of one potential embodiment of a battery-powered extension cord device of the present invention while the power cord is extended from the body in accordance with the disclosed architecture;

FIG. 3 illustrates an enhanced perspective view of a battery of one potential embodiment of a battery-powered extension cord device of the present invention in accordance with the disclosed architecture;

FIG. 4 illustrates an enhanced perspective view of a timer and button of one potential embodiment of a battery-powered extension cord device of the present invention in accordance with the disclosed architecture;

FIG. 5 illustrates a flowchart of a method of using one potential embodiment of a battery-powered extension cord device of the present invention in accordance with the disclosed architecture; and

FIG. 6 illustrates a flowchart of a method of using one potential embodiment of a battery-powered extension cord device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved extension cord. There also exists a long-felt need in the art for a battery-powered extension cord device. More specifically, there exists a long-felt need in the art for a battery-powered extension cord device that can be positioned near an electronic device it is powering without the need for daisy-chaining. Further, there exists a long-felt need in the art for a battery-powered extension cord device that can be positioned near an electronic device it is powering without the need for daisy-chaining, and wherein the device need not receive continuous electrical power from an electrical outlet.

The present invention, in one exemplary embodiment, is comprised of a battery-powered extension cord device comprised of at least one battery which powers at least one power cord. As a result, the device can be positioned near an electronic device it is supplying power to and can do so without the need for an electrical outlet. The device is comprised of a body comprised of at least one opening. The opening allows at least one power cord to exit the body. Within the body, the power cord is stored around at least one reel. The cord is comprised of a first end and a second end. The first end of the cord is in electrical communication with at least one battery within the body which provides power to the cord. In one embodiment, the battery is replaceable and disposable. In another embodiment, the battery via at least one charging port and/or via at least one male power cord that plugs into a 110 v/220 v wall outlet.

The second end of the power cord is comprised of at least one receptacle that is preferably a female 110 v/220 v power receptacle. As a result, the male plug of an electronic device can be plugged into the receptacle and powered by the device. At least one button on the body may allow a user to configure at least one timer of the device to allow a user to program the battery to only supply power to the receptacle for a specific period of time.

The present invention is also comprised of a method of using the device. First, a device is provided comprised of a body comprised of at least one reel, at least one power cord comprised of at least one receptacle, and at least one battery. Then, the power cord can be pulled from the body. Next, the male plug of an electronic device can be plugged into the receptacle such that the electronic device receives electrical power from the battery. The cord can then be retracted within the body when the electronic device is not in use.

In a second method of using the device, a device is provided comprised of a body comprised of at least one reel, at least one power cord comprised of at least one receptacle, and at least one battery. Then, the power cord can be pulled from the body. Next, the male plug of an electronic device can be plugged into the receptacle such that the electronic device receives electrical power from the battery. Then, at least one timer of the device can be configured to a specific time period wherein the battery will supply power to the receptacle. The cord can then be retracted within the body when the electronic device is not in use.

Accordingly, the battery-powered extension cord device of the present invention is particularly advantageous as it provides an improved extension cord. More specifically, the device can be positioned near an electronic device it is powering without the need for daisy-chaining. Further, the device need not receive continuous electrical power from an electrical outlet. In this manner, the battery-powered extension cord device overcomes the limitations of existing extension cords known in the art.

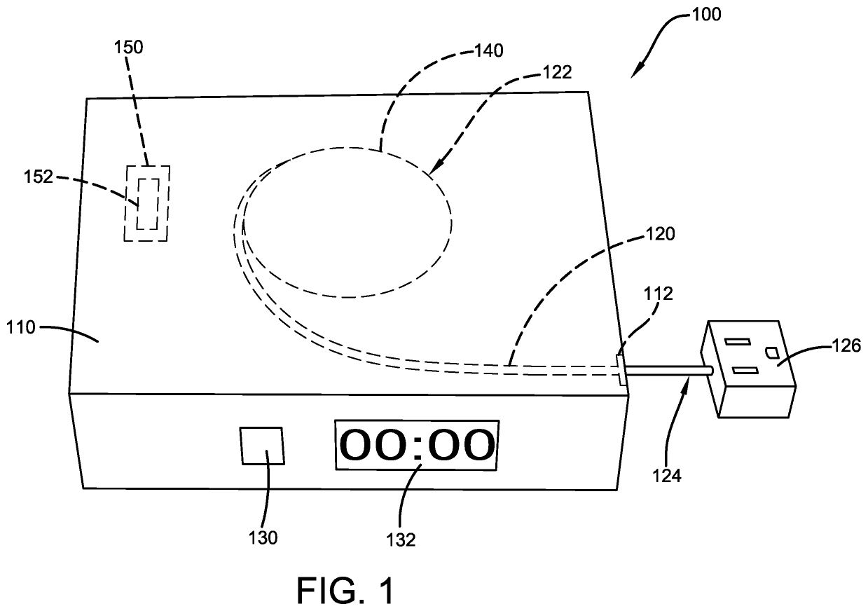

Referring initially to the drawings, FIG. 1 illustrates a perspective view of one potential embodiment of a battery-powered extension cord device 100 of the present invention while the power cord 154 is retracted into the body 110 in accordance with the disclosed architecture. The device 100 is comprised of at least one battery 150 which powers at least one power cord 120. As a result, the device 100 can be positioned near an electronic device it is supplying power to. Therefore, daisy chaining is not needed to reach the electronic device. Further, the battery 150 allows the device 100 to supply power on a timer and without the need for an electrical outlet.

The device 100 is comprised of a body 110. The body 110 may be any shape in different embodiments. The body 110 is comprised of at least one opening 112. The opening 112 allows at least one power cord 120 to exit the body 110.

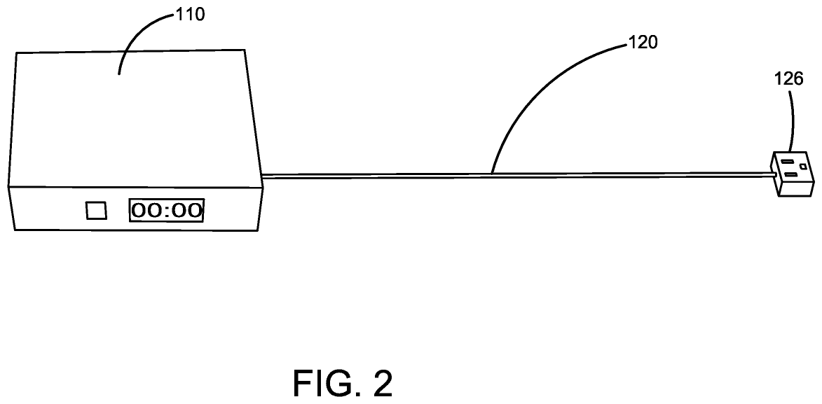

Within the body 110, the power cord 120 is stored around at least one reel 140. The reel 140 is preferably a spring loaded reel. In this manner, the reel 140 allows the cord 120 to be automatically retracted into and stored within the body 110 when not in use. When the cord 120 is pulled from the body 110, as seen in FIG. 2, the reel 140 can be automatically locked at a desired position to achieve a desired cord 120 length.

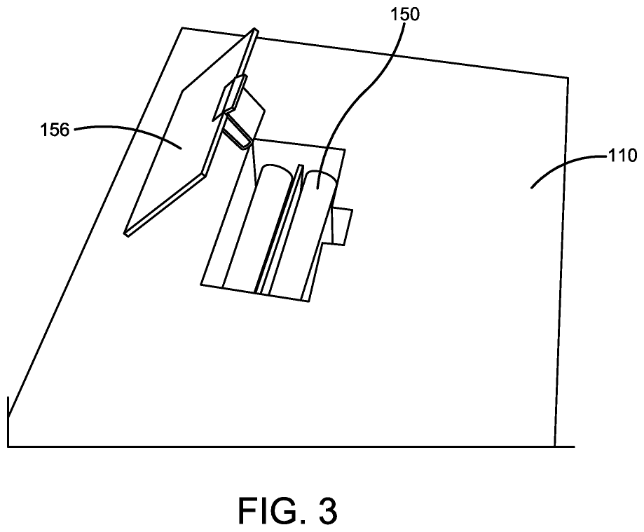

The cord 120 is comprised of a first end 122 and a second end 124. The first end 122 of the cord 120 is in electrical communication with at least one battery 150 within the body 110. The battery 150 provides power to the cord 120 and can be any type of battery, including convention and lithium. In one embodiment, the battery 150 is replaceable and disposable. In another embodiment, the battery 150 is rechargeable. In a rechargeable embodiment, the battery 150 may be recharged via at least one charging port 152. The port 152 may be but is not limited to a USB port. In another embodiment, the battery 150 can be charged via at least one male power cord 154 that plugs into a 110 v/220 v wall outlet. In one embodiment, the battery 150 may be accessed by removing at least one battery cover 156 from the body 110, as seen in FIG. 3.

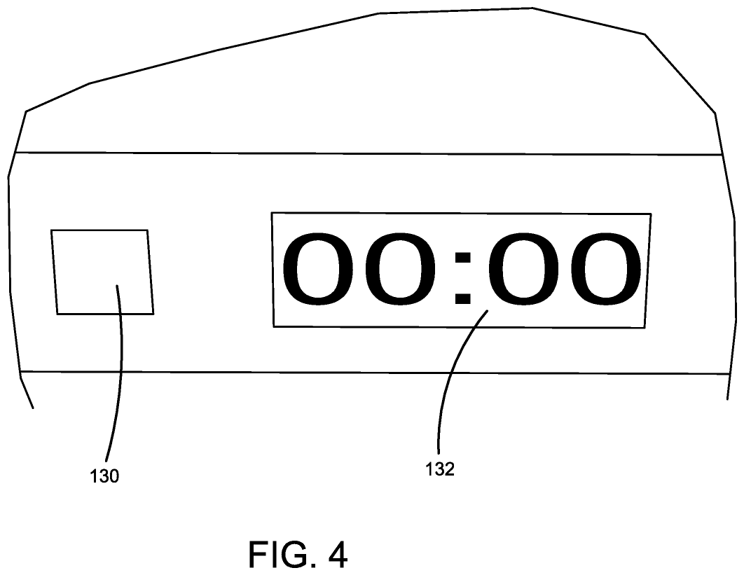

The second end 124 of the power cord 120 is comprised of at least one receptacle 126. The receptacle 126 is preferably a female 110 v/220 v power receptacle. As a result, the male plug of an electronic device can be plugged into the receptacle 126 and powered by the device 100. At least one button 130 on the body 110 may allow a user to configure at least one timer 132 of the device 100, as seen in FIG. 4. The timer 132 allows a user to program the battery 150 to only supply power to the receptacle 126 for a specific period of time. As a result, any electronic device attached to the device 100 may only be powered for a specific period of time.

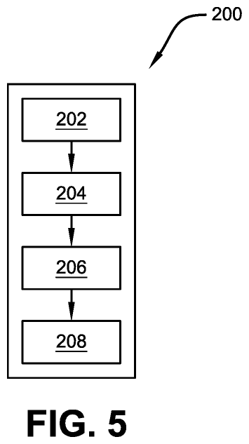

The present invention is also comprised of a method of using 200 the device 100, as seen in FIG. 5. First, a device 100 is provided comprised of a body 110 comprised of at least one reel 140, at least one power cord 120 comprised of at least one receptacle 126, and at least one battery 150 [Step 202]. Then, the power cord 120 can be pulled from the body 110 [Step 204]. Next, the male plug of an electronic device can be plugged into the receptacle 126 such that the electronic device receives electrical power from the battery 150 [Step 206]. The cord 120 can then be retracted within the body 110 when the electronic device is not in use [Step 208].

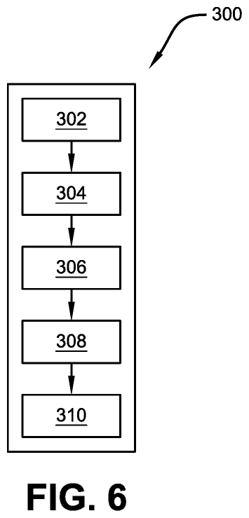

The present invention is also comprised of a second method of using 300 the device 100, as seen in FIG. 6. First, a device 100 is provided comprised of a body 110 comprised of at least one reel 140, at least one power cord 120 comprised of at least one receptacle 126, and at least one battery 150 [Step 302]. Then, the power cord 120 can be pulled from the body 110 [Step 304]. Next, the male plug of an electronic device can be plugged into the receptacle 126 such that the electronic device receives electrical power from the battery 150 [Step 306]. Then, at least one timer 132 of the device 100 can be configured to a specific time period wherein the battery 150 will supply power to the receptacle 126 [Step 308]. The cord 120 can then be retracted within the body 110 when the electronic device is not in use [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “battery-powered extension cord device” and “device” are interchangeable and refer to the battery-powered extension cord device 100 of the present invention.

Notwithstanding the forgoing, the battery-powered extension cord device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the battery-powered extension cord device 100 as shown in the FIGS. are for illustrative purposes only, and that many other sizes and shapes of the battery-powered extension cord device 100 are well within the scope of the present disclosure. Although the dimensions of the battery-powered extension cord device 100 are important design parameters for user convenience, the battery-powered extension cord device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A battery-powered extension cord device comprising:
a body;
a reel positioned within the body;
a first power cord comprised of a receptacle; and
a battery.

2. The battery-powered extension cord device of claim 1, wherein the battery is comprised of a disposable battery.

3. The battery-powered extension cord device of claim 1, wherein the battery is comprised of a rechargeable battery.

4. The battery-powered extension cord device of claim 3, wherein the rechargeable battery is recharged via a charging port of the battery.

5. The battery-powered extension cord device of claim 3, wherein the rechargeable battery is recharged via a second power cord.

6. The battery-powered extension cord device of claim 1, wherein the reel is comprised of a spring-loaded reel.

7. The battery-powered extension cord device of claim 1, wherein the receptacle is comprised of a female 110 v or 220 v receptacle.

8. A battery-powered extension cord device comprising:
a body;
a reel positioned within the body;
a power cord comprised of a receptacle;
a battery; and
a timer.

9. The battery-powered extension cord device of claim 1, wherein the power cord is in electrical communication with the battery.

10. The battery-powered extension cord device of claim 9, wherein the timer controls how long the power cord receives electrical power from the battery.

11. The battery-powered extension cord device of claim 8, wherein the timer can be configured by the button.

12. The battery-powered extension cord device of claim 8, wherein the body is comprised of a battery cover.

13. The battery-powered extension cord device of claim 8, wherein the battery is comprised of a disposable battery.

14. The battery-powered extension cord device of claim 8, wherein the battery is comprised of a rechargeable battery.

15. The battery-powered extension cord device of claim 14, wherein the rechargeable battery is recharged via a charging port of the battery.

16. The battery-powered extension cord device of claim 14, wherein the rechargeable battery is recharged via a second power cord.

17. The battery-powered extension cord device of claim 8, wherein the reel is comprised of a spring-loaded reel.

18. The battery-powered extension cord device of claim 8, wherein the receptacle is comprised of a female 110 v or 220 v receptacle.

19. A method of using a battery-powered extension cord device, the method comprising the following steps:
providing a battery-powered extension cord device comprised of a body comprised of a reel, a power cord comprised of a receptacle, and a battery;
pulling the power cord from the body; and
plugging in a male plug of an electronic device into the receptacle.

20. The method of using a battery-powered extension cord device of claim 19 further comprised of a step of configuring a timer of the battery-powered extension cord device.
